(19) United States
(12) Patent Application Publication
(10) Pub. No.: US 2005/0042933 A1
(43) Pub. Date: Feb. 24, 2005

(54) Electrical connection device with protected contact

(75) Inventor: Johann Cisey, Saint Symphorien D'Ancelles (FR)

Correspondence Address: OLIFF & BERRIDGE, PLC, P.O. BOX 19928, ALEXANDRIA, VA, 22320, US

(73) Assignee: ABB ENTRELEC, Villeurbanne (FR)

(21) Appl. No.: 10/893,491

(22) Filed: Jul. 19, 2004

(30) Foreign Application Priority Data
Jul. 22, 2003 (FR) 03.08935

(51) Int. Cl. H01R 9/22

(52) U.S. Cl. 439/709

(57) ABSTRACT

This is a connection device comprising an insulating case and it defines at least one housing and various connection openings and work openings, an electrical contact plate, a screw mounted in the housing, and clamping means stressed by the screw in order when required to immobilize together the conducting element and the contact plate. The case comprises means for retaining the screw inside the housing so that only the head of the screw is accessible from the outside through the work opening, the clamping means being completely insulated from the outside by the case, and rotation of the screw moves the clamping means translationally inside the housing between two separate positions at a distance from each other.

### BACKGROUND OF THE INVENTION

The present invention relates to electrical connection devices particularly for allowing electrical connection between a contact plate belonging to the device and an electrical element external to this device.

### DESCRIPTION OF THE PRIOR ART

The devices usually met with are the type comprising:
a case made of an electrically insulating material which defines at least one housing and which has at least one connection opening for the insertion into the housing of an electrically conducting element from outside of the device, and at least one work opening for the passage of a work tool,
at least one electrical contact plate comprising at least one web situated in the housing and at least one leg projecting out of the case,
at least one screw comprising a threaded shank and a driving head, which screw is mounted movably inside the housing so as to be turned by the tool, and
clamping means which are mounted in the housing in such a way as to be stressed by the screw in order when required to immobilize together the conducting element and the contact plate.

Although such devices are perfectly satisfactory in terms of the electrical connection between the conductors and the contact plates, the insertion of the conducting element into the housing underneath the screw head is often a difficult task requiring the operator's direct intervention. Disassembly also frequently necessitates the handling of electrically conducting components. Sometimes, during these operations, the operator may accidentally make contact with the electrical current.

It should also be pointed out that regulations require that the clamping components be made of a conducting material. This is because insulating materials made of plastic flow as the temperature increases, reducing the clamping force on the wire.

### SUMMARY OF THE INVENTION

It is an object of the present invention to remedy the abovementioned drawbacks by providing a connection device whose design rules out the possibility of the operator making contact with the electrically conducting components, and this by simple, effective and inexpensive means.

To this end, according to the present invention, the connection device of the abovementioned type is essentially a device wherein the case comprises means for retaining the screw inside the housing so that only the head of the screw is accessible from the outside through the work opening, the clamping means made of a conducting material being completely insulated from the outside by the case, and in that rotation of the screw moves the clamping means translationally inside the housing in a direction parallel to the shank of the screw between two separate positions at a distance from each other, a clamping position in which the conducting element and the contact plate are immobilized together and a disengaged position in which the conducting element is free.

Thus, with these arrangements, the case of the device constitutes an electrically insulating envelope, the only openings of which are designed for the passage of screwdriving tools and conducting elements. Movement of the screw causes movement of the electrically conducting components yet prevents the operator from coming into contact with the electrically conducting components enclosed within the housing of the case.

Preferably, nut means are immobilized in the housing in such a way as to engage with the shank of the screw.

Advantageously, the device also comprises elastic restoring means which stress the screw in such a way that the screw head is pushed against the means for retaining the screw inside the housing, moving the clamping means towards their disengaged position.

Preferably, the nut means are situated in the bottom of the housing opposite the work opening.

Also preferably, the nut means are part of the same mass of material as the contact plate.

As a variant, the clamping means comprise a thin element through which the shank of the screw passes and which is held by a larger-diameter section of said shank.

Also preferably, the clamping means consist of the elastic restoring means which deform when the screw engages with the nut means.

In a preferred embodiment, the nut means are immobilized inside the housing and separated from the work opening by a distance equal to at least the length of the screw.

Advantageously, the clamping means are the free end of the screw.

Also preferably, the clamping means comprise a stirrup-shaped hook having a first arm situated near the head of the screw and a second arm bearing against the free end of the screw.

Advantageously, the nut means are held in position by a leg that is part of the same mass of material as the web of the contact plate and that extends transversally to the screw shank.

Also advantageously, the nut means are part of the same mass of material as said transverse leg of the contact plate.

Preferably, the second arm of the hook comprises at least two tabs bent towards the web of the contact plate.

As a variant, rotation of the screw moves the screw translationally through the nut means, driving the hook between the clamping and disengaged positions.

Preferably, the contact plate comprises two extensions which extend transversally relative to the shank of the screw at a distance from each other such that one comes into contact with the underside of the head of the screw and one with the underside of the free end of the screw, and both at a distance from the web of the contact plate.

As a variant, the clamping means comprise a cage with open side faces which is moved by the rotation of the screw and which comprises a first transverse wall engaged by the thread of the screw and a second transverse wall able to move between the web of the contact plate and the extension of the contact plate against which the screw bears.

### DESCRIPTION OF THE DRAWINGS

However, the present invention will become clear in the course of the following description, reference being made to the appended diagrammatic drawing showing, as non-restrictive examples, eight embodiments of the connection device according to the present invention.

FIGS. 1 to 3 are, in order, a perspective view with partial cut-away, a longitudinal section, and a transverse section of the connection device in a first embodiment of the present invention.

FIGS. 4 to 6, 7 to 9, 10 to 12 and 13 to 15 are figures similar to FIGS. 1 to 3 of the second, third, fourth and fifth embodiments, respectively, of the device according to the present invention.

FIG. 16 is a transverse sectional view of a variant of the fifth embodiment of the device of the present invention shown in FIGS. 13 to 15.

FIGS. 17 to 19, 20 to 22 and 23 to 25 are views similar to FIGS. 1 to 3 of the sixth, seventh and eight embodiments, respectively, of the device of the present invention.

### DESCRIPTION OF THE PREFERRED EMBODIMENTS

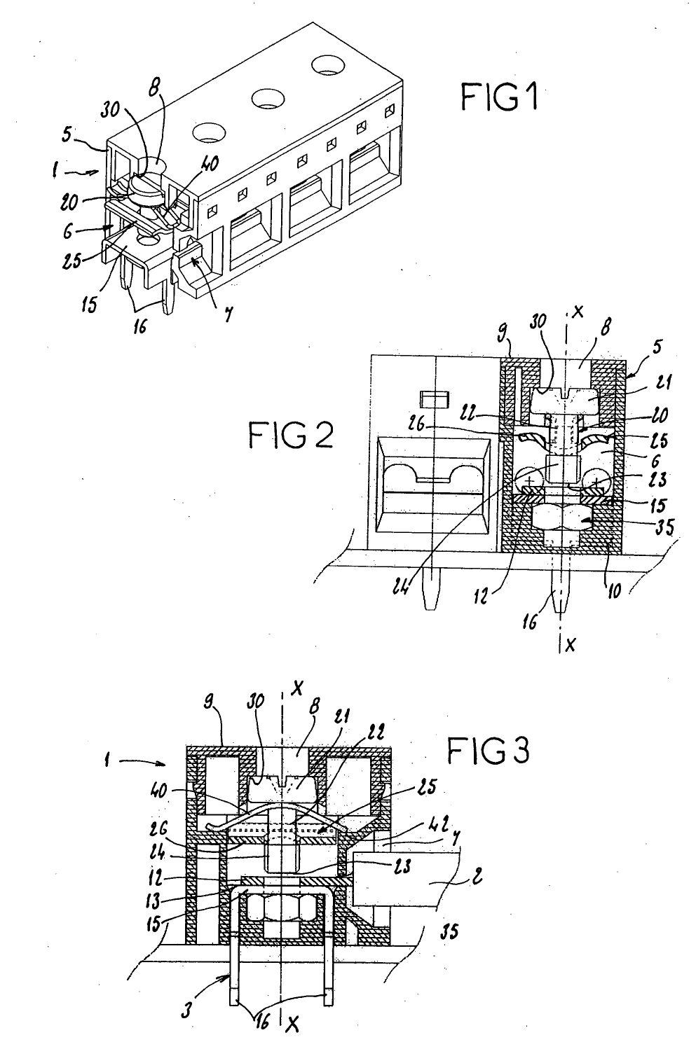

The electrical connection device 1 according to a first embodiment of the invention shown in FIGS. 1 to 3 is for connecting a conducting element 2 external to the device, to an electrical contact plate 3 belonging to this device.

The connection device described below can of course be understood as a connection terminal or a socket panel and the conducting element may be either a conducting cable with a stripped end, or a conducting ring terminal.

The electrical contact plate 3 may for example be embedded in an electronic board or in any other electrical system.

The connection device 1 comprises a case 5 which is made of an electrically insulating material and defines at least one housing 6. This electrically insulating case forms a virtually closed envelope vis-à-vis the external environment and comprises a connection opening 7 designed to allow the electrically conducting element 2 to be inserted into the housing 6 from the exterior of the device, and a work opening 8 for the passage of a work tool into the interior of the housing 6.

The case 5 may consist for example of two halves 9 and 10 fixed together following assembly of the component parts, described below, of the device 1.

The conducting element 2 possesses a terminal end 12 and takes the form of for example a flat ring terminal which is intended to be inserted into the housing 6.

The contact plate 3 comprises a web 15 which extends across the bottom 13 of the housing 6 and is connected to two legs 16 projecting from the case 5. The contact plate 3 is thus situated opposite the work opening 8.

The device 1 also has a screw 20 made up of a driving head 21 from which extends a threaded shrank 22 having a free end 23 at the opposite end from the head 21. This screw 20 is of axis X-X and extends basically in the direction corresponding to the height of the case 5. It is able to move within the housing 6 when driven by the rotation of the work tool (not shown).

The device 1 also comprises clamping means 25 made of a conducting material mounted inside the housing 6 in such a way that they are stressed by the screw 20 in order when required to immobilize together the conducting element 2 and the contact plate 3.

An essential feature of the present invention is that the case 5 possesses retaining means 30 which make it possible to imprison the screw 20 inside the housing 6 and which are situated in the vicinity of the work opening 8. These retaining means 30 make only the head 21 of the screw 20 accessible from the outside, so the clamping means 25 are completely integrated by the case 5 from the external environment.

Another essential feature of the present invention is that rotation of the screw 20 with the aid of an external work tool causes the clamping means 25 to move inside the housing 6 with a translation movement parallel to the shank 22 of this screw, between two separate positions at a distance from each other, namely a clamping position in which the conducting element 2 and the contact plate 3 are immobilized together (this position not shown) and a disengaged position, shown in the figures, in which the conducting element 2 is free to be withdrawn from the case 5.

Nut means 35 are also immobilized inside the housing 6 for engagement with the shank 22 of the screw 20 when the screw is turned.

The connection device 1 furthermore possesses elastic restoring means 40 that stress the screw 20 in such a way as to push the head 21 of this screw 20 against the retaining means 30 belonging to the case 5, on the inside of the housing 6, when it is not engaged with the nut means. When the screw 20 is pushed against these means (the top position in the housing 6, close to the work opening 8), it takes with it the clamping means 25 into their disengaged position.

In the first embodiment shown in FIGS. 1 to 3, the elastic restoring means 40 take the form of a spring wire interposed between the underside of the head 21 of the screw 20, and the flats 42 projecting into the housing 6 from the walls of the case 5, approximately at right angles to the axis X-X of the screw 20. This spring wire 40 possesses an elastic force tending to push the head 21 back against the retaining means 30 of the case 5, into a position in which the clamping means 25 leave the conductor 2 free to be engaged or disengaged from the housing 6.

The clamping means 25 in this embodiment take the form of a thin element 26 through which the shrank 22 of the screw 20 passes and which rests on a shoulder on this shank formed by a section 24 of larger diameter than the rest of the shank 22 of the screw.

Also, the nut means 35 are immobilized in the bottom 13 of the housing 6. These means take the form of a multisided nut permanently immobilized on the other side of the web 15 of the contact plate 3 from the screw 20.

It will be understood therefore that, following insertion of the ring terminal 12 of the conducting element 2 into the housing 6, so that it lies on the web 15 of the plate 3, the screw head 21 can be stressed by the work tool in order to be driven down, against the force of the spring wire 40, through the housing 6 and towards the bottom 13 to engage with the nut 35. The screw 20 then has a translational movement downward into the bottom of the housing 6, taking with it the thin clamping element 26 in order to immobilize the ring terminal 12 against the contact plate 3.

On the other hand, when the conducting element 2 is to be electrically disconnected, the screw 20 is simply unscrewed by means of the external tool. The screw is then automatically given, by the spring wire 40, an upward translational movement, taking the thin clamping element 26 with it. The operator does not have to lift the screw or the thin element with his fingers in order to disengage the conductor 2.

It will thus be appreciated that the device 1 according to the present invention makes it possible to connect and disconnect the conducting element 2 without the operator being able to touch the conducting parts. The risk of accidents is thus minimized.

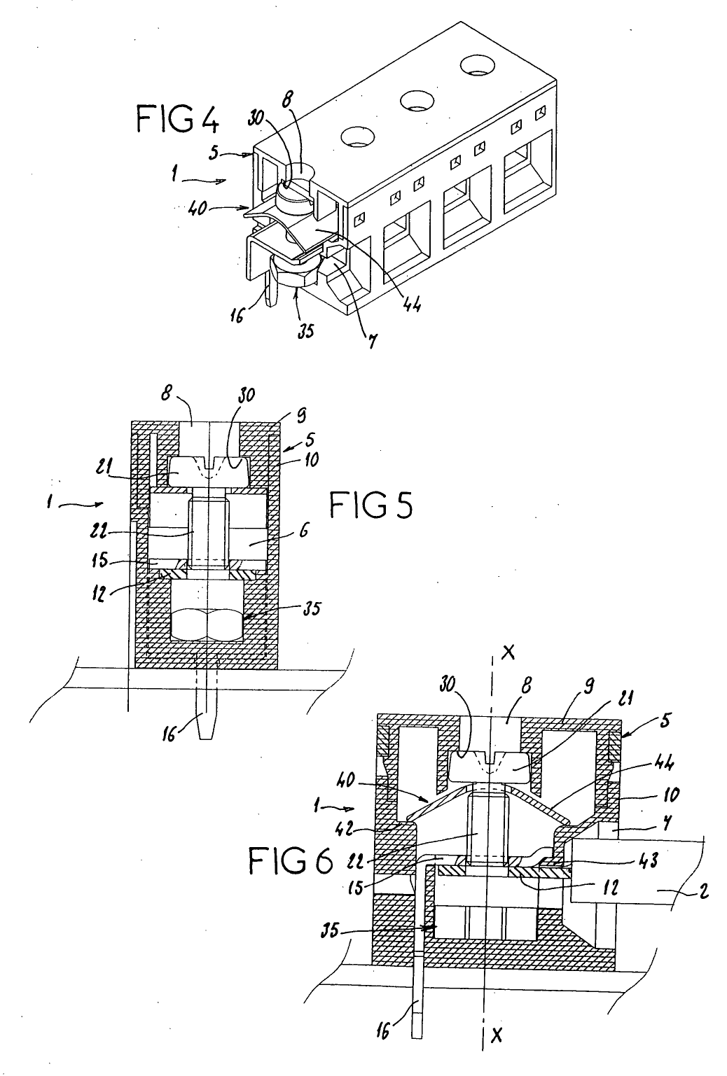

In the second embodiment shown in FIGS. 4 to 6, the clamping means 25 take the form of an internally threaded hole formed in the ring terminal 12 of the conducting element 2. The same reference numbers denote components identical or similar to the previous embodiment. The elastic restoring means 40 take the form of a thin element 44 which is also pressed against the flats 42 projecting from the walls 5 of the case as in the previous embodiment.

This second embodiment differs from the first embodiment in that the web 15 of the contact plate 3 is in contact with a flat 43 on one of the walls of the case 5 in the vicinity of the connection opening 7. The ring terminal 12 of the conducting element 2 is inserted into the opening 7 and laid against the web 15 of the plate 3, on the underside of the latter and bearing against the edge of the opening 7 from which the flat 43 projects.

Thus, after having put the conducting element 2 in position inside the housing 6, the screw 20 is made to rotate against the thin spring element 44 so that it passes through first the web 15 of the plate 3, and then through the ring terminal 12 to reach the nut 35 held in the bottom of the case 5. As screwing proceeds, the ring terminal 12 is pressed against the web 15 to establish a good electrical contact without manual assistance by the operator inside the case 5.

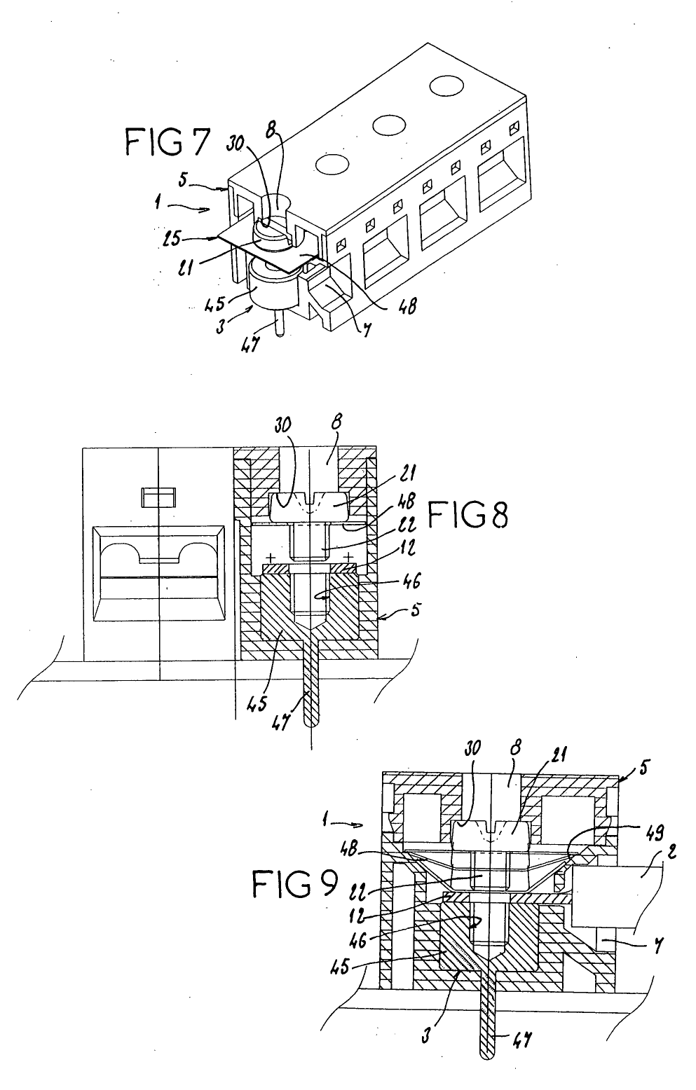

In the third embodiment shown in FIGS. 7 to 9, the nut means 35 are part of the same mass of material as the contact plate 3, the web 45 of which takes the form of a cylindrical pin of the same axis as the screw 20. The web 45 of the plate 3 possesses, in the side nearest the screw 20, an internally threaded hole 46, and is extended on the far side by a leg 47 extending out of the case 5.

Furthermore, the elastic restoring means 40 act as clamping means and take the form of a leaf spring 48 placed between the underside of the head 21 of the screw 20, and the slopes 49 projecting into the housing 6 from the case 5.

Thus, having placed the ring terminal 12 of the conducting element 2 inside the housing 6, the screw 20 is driven towards the bottom of the housing 6 and screwed into the web 45 of the plate 3. The head 21 of the screw 20 deforms the thin element 48 which presses against the ring terminal 12 to push this ring terminal firmly against the web 45 of the plate 3.

The embodiments described below differ from the previous embodiments in the sense that the nut means 35 in these cases are not immobilized in the bottom of the housing 6 but are immobilized at an intermediate level defining a gap with the work opening 8, the length of which, measured along the axis X-X, is equal to or greater than the length of the screw 20.

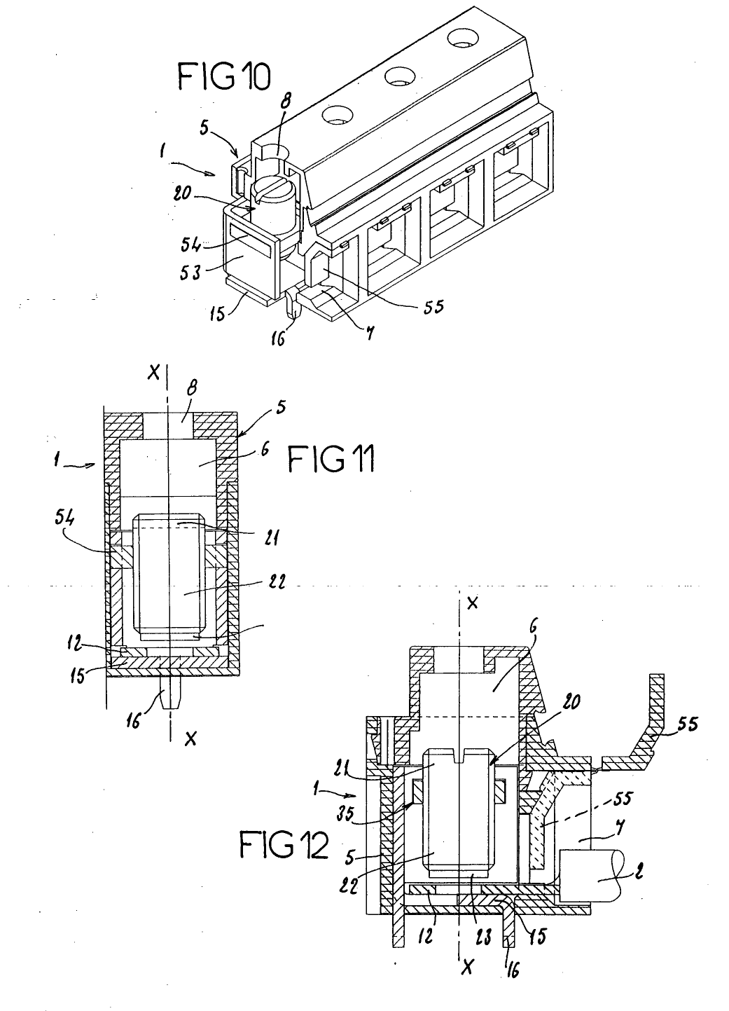

In the fourth embodiment shown in FIGS. 10 to 12, the shank 22 and the head 21 are of the same diameter. The clamping means 25 are represented in by the free end 23 of the screw 20. Thus, after inserting the ring terminal 12 of the conducting element 2 into the housing 6 for it to contact the web 15 of the plate 3, the screw 20 is simply screwed through the nut means 35 to bring the free end 23 against the ring terminal 12 and sandwich it between it and the web 15 of the plate 3.

As shown more particularly in FIG. 10, the nut means 35 are carried by walls 53 which are part of the same mass of material as the web 15 of the plate 3 and extend in the direction of the work opening 8, inside the housing 6. The nut means 35 take the form of an internally threaded thin element 54 extending transversely with respect to the screw 20.

Also, the connection opening 7 is closed by a hinged flap 55 supported by one of the walls of the case 5 and illustrated in the open and closed positions.

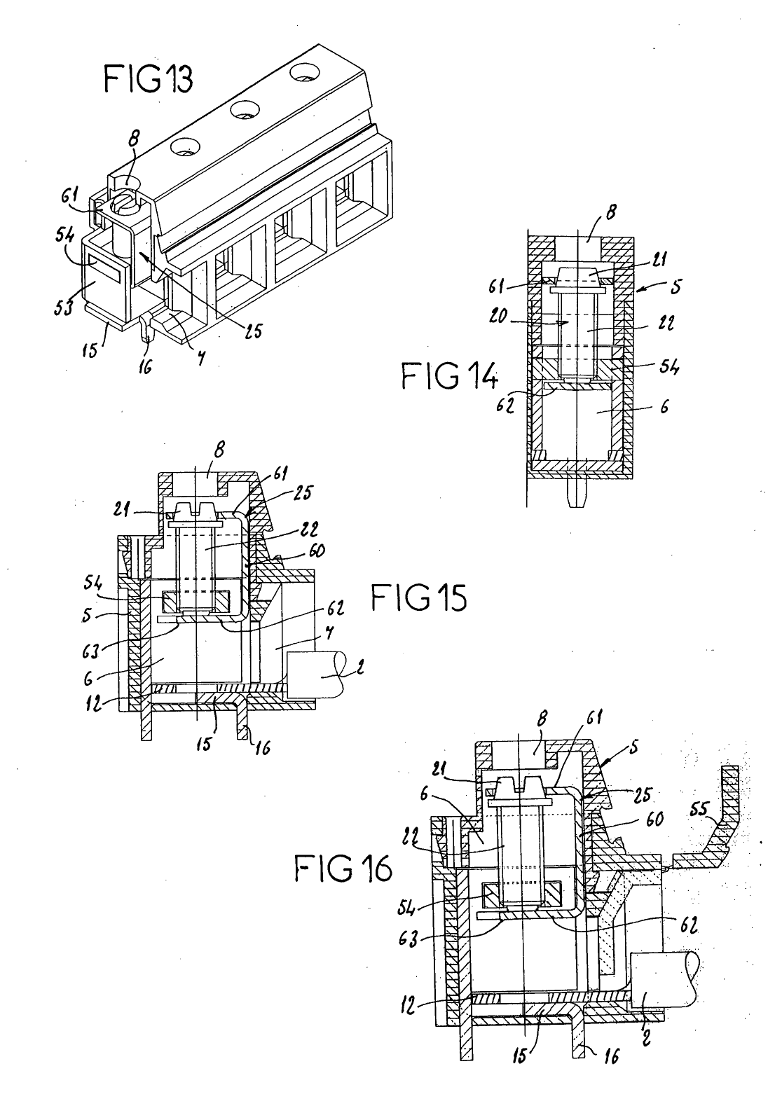

The fifth embodiment shown in FIG. 13 to 15 differs from the above fourth embodiment in the clamping means 25 which here take the form of a hook 60. This hook is shaped like a stirrup with a first arm 61 near the head 21 of the screw 20 and a second arm 62 bearing against the free end 23 of the screw 20.

As shown more particularly in FIG. 15, the screw 20 is mounted on the immobile nut means 35 (the internally threaded thin element 54, as in the previous embodiment) in such a way that turning the screw moves the screw translationally along its axis X-X. The hook 60 is integral with the translational movement of this screw and so is similarly driven between the clamping and disengaged positions as the screw 20 is turned clockwise or anticlockwise. In the clamping position, the second arm 62 presses the ring terminal 12 of the conducting element 2 firmly against the web 15 of the contact plate 3. To further improve the immobilization of the ring terminal 12, the second arm 62 has a tooth 63 consisting of a cutout inside this arm. Similarly, disconnecting the conductor 2 does not require the direct intervention of the operator because the screw rises due to the effect of the rotation.

In the variant shown in FIG. 16, the case 5 has a flap 65 hinged to one of these walls in order to open or close the connection opening 7.

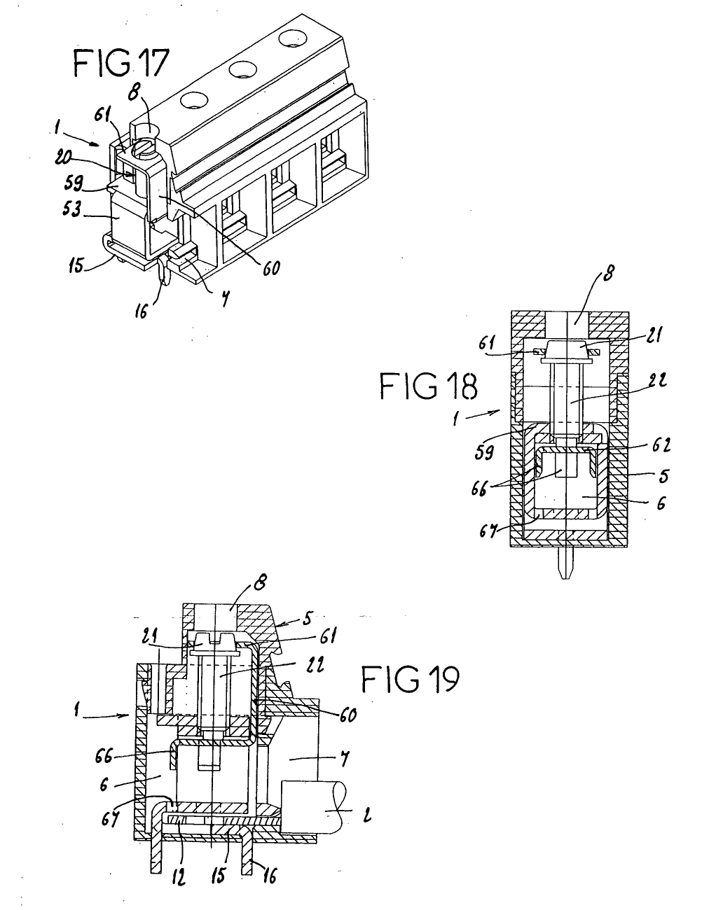

In the sixth embodiment shown in FIGS. 17 to 19, the nut means 35 are part of the same mass of material as the plate 3, more specifically part of the same mass as the transverse leg 59 of this plate. In this embodiment the transverse leg 59 and the side legs 63 form with the web 15 of the plate 3 a cage comprising at least one open face exposed to the connection opening 7.

The hook 60 is moved by the screw 20 as in the previous embodiment. The second arm 62 has three tabs 66 pointing towards the web 15 of the contact plate 3, that is towards the bottom of the housing 6 in order to engage, when in the clamping position on the conducting element 2, with notches 67 formed in the web 15 of the plate 3.

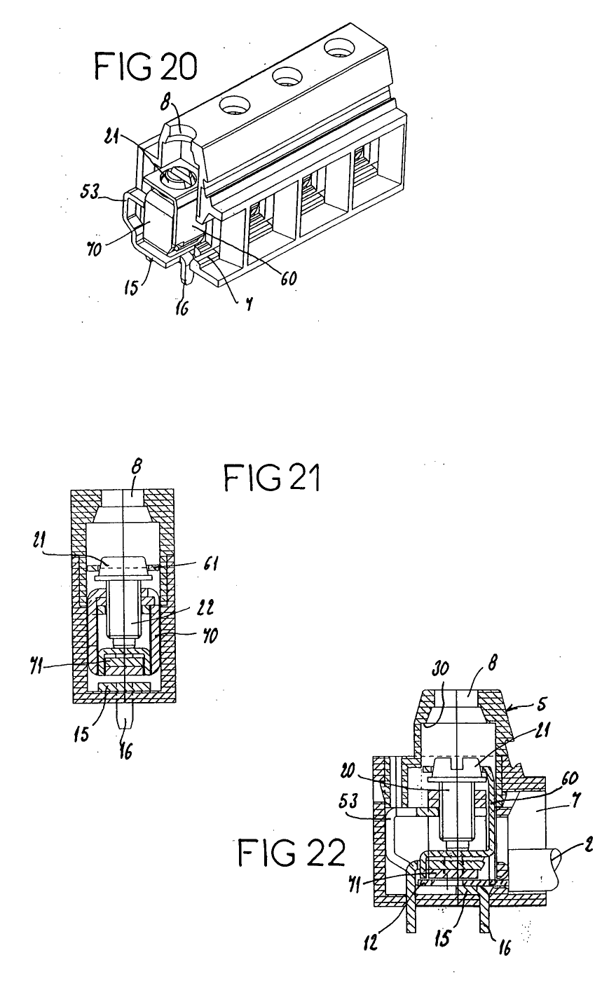

In the seventh embodiment shown in FIGS. 20 to 22, the nut means 35 are no longer formed in the plate 3 but are represented by a hollow pin 70 interposed between the head 21 of the screw 20 and an extension 71 projecting from the face 53 of the contact plate 3.

The pin is kept immobile by the transverse extensions of the contact plate so that the screw is able to move translationally relative to this pin and carries the hook 60 with it to either clamp the ring terminal 12 against the web of the plate 3 or release it.

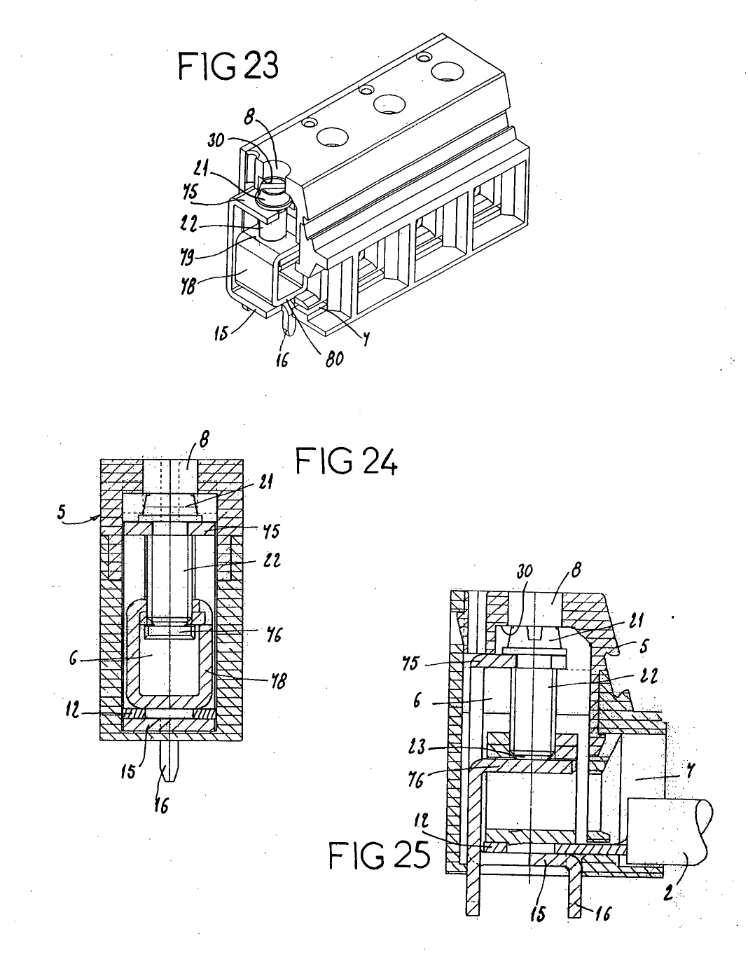

The eighth embodiment shown in FIGS. 23 to 25 makes it possible to connect electrically either a ring terminal 12 or a bare end of a conductor depending on the direction of rotation of the screw 20. For this purpose the plate 3 comprises two transverse extensions 75 and 76 with the screw 20 between them, the extension 75 being situated underneath the screw head 21 and the extension 76 bearing underneath the free end 23 of the screw 20. In addition, the device comprises a cage 78 with open lateral faces to serve as a clamping means, in which a first transverse wall 79 engages by screw action with the shank 22 of the screw 20 and a second transverse wall 80 is used to clamp either the ring terminal 12 on its face nearest the web 15, or a bare end of a conductor on its opposite face, that is nearest the screw 20, depending on the direction in which the screw 20 is turned.

The invention is not of course limited to the examples described above, and various modifications may be made to it without departing from its scope.

1. An electrical connection device for connecting an inserted conducting element to an electrical contact plate, comprising:
a case made of an electrically insulating material which defines at least one housing and which has at least one connection opening for the insertion into the housing of an electrically conducting element from outside of the device, and at least one work opening for the passage of a work tool,
at least one electrical contact plate comprising at least one web situated in the housing and at least one leg projecting out of the case,
at least one screw comprising a threaded shank and a driving head, which screw is mounted movably inside the housing so as to be turned by the tool, and
clamping means which are mounted in the housing in such a way as to be stressed by the screw in order when required to immobilize together the conducting element and the contact plate,
wherein the case comprises means for retaining the screw inside the housing so that only the head of the screw is accessible from the outside through the work opening, the clamping means made of a conducting material being completely insulated from the outside by the case, and in that rotation of the screw moves the clamping means translationally inside the housing in a direction parallel to the shank of the screw between two separate positions at a distance from each other, a clamping position in which the conducting element and the contact plate are immobilized together and a disengaged position in which the conducting element is free.

2. The connection device as claimed in claim 1, wherein nut means are immobilized in the housing in such a way as to engage with the shank of the screw.

3. The connection device as claimed in claim 2, wherein the device also comprises elastic restoring means which stress the screw in such a way that the screw head is pushed against the means for retaining the screw inside the housing, moving the clamping means towards their disengaged position.

4. The connection device as claimed in claim 1, wherein the nut means are situated in the bottom of the housing opposite the work opening.

5. The connection device as claimed in claim 4, wherein the nut means are part of the same mass of material as the contact plate.

6. The connection device as claimed in claim 1, wherein the clamping means comprise a thin element through which the shank of the screw passes and which is held by a larger-diameter section of said shank.

7. The connection device as claimed in claim 2, wherein the clamping means consist of the elastic restoring means which deform when the screw engages with the nut means.

8. The connection device as claimed in claim 2, wherein the nut means are immobilized inside the housing and separated from the work opening by a distance equal to at least the length of the screw.

9. The connection device as claimed in claim 8, wherein the clamping means are the free end of the screw.

10. The connection device as claimed in claim 8, wherein the clamping means comprise a stirrup-shaped hook having a first arm situated near the head of the screw and a second arm bearing against the free end of the screw.

11. The connection device as claimed in claim 10, wherein the nut means are held in position by a leg that is part of the same mass of material as the web of the contact plate and that extends transversally to the screw shank.

12. The connection device as claimed in claim 11, wherein the nut means are part of the same mass of material as said transverse leg of the contact plate.

13. The connection device as claimed in claim 10, wherein the second arm of the hook comprises at least two tabs bent towards the web of the contact plate.

14. The connection device as claimed in claim 10, wherein rotation of the screw moves the screw translationally through the nut means, driving the hook between the clamping and disengaged positions.

15. The connection device as claimed in claim 10, wherein the contact plate comprises two extensions which extend transversally relative to the shank of the screw at a distance from each other such that one comes into contact with the underside of the head of the screw and one with the underside of the free end of the screw, and both at a distance from the web of the contact plate.

16. The connection device as claimed in claim 15, wherein the clamping means comprise a cage with open side faces which is moved by the rotation of the screw and which comprises a first transverse wall engaged by the thread of the screw and a second transverse wall able to move between the web of the contact plate and the extension of the contact plate against which the screw bears.
